(19) United States
(12) Patent Application Publication
(10) Pub. No.: US 2010/0075618 A1
(43) Pub. Date: Mar. 25, 2010

(54) SIGNAL PROCESSING APPARATUS AND RADAR APPARATUS

(75) Inventor: Osamu ISAJI, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/562,720

(22) Filed: Sep. 18, 2009

(30) Foreign Application Priority Data
Sep. 19, 2008 (JP) 2008-240998

(51) Int. Cl. H04B 1/38

(52) U.S. Cl. 455/90.1

(57) ABSTRACT

A signal processing apparatus is to be incorporated in a radar transmitter receiver including a transmission antenna which is configured to transmit a transmission signal, a plurality of reception antennas each of which is configured to receive the transmission signal reflected by a target object, and a generator which is configured to generate a plurality of beat signals for each of the receiving antennas. A synthesizer is configured to synthesize the beat signals to generate a synthesized beat signal. A detector is configured to detect an azimuth angle of the target object based on the synthesized beat signal and one of the beat signals.

The disclosure of Japanese Patent Application No. 2008-240998 filed on Sep. 19, 2008 including specification, drawings and claims is incorporated herein by reference in its entirety.

### BACKGROUND

The present invention relates to a signal processing apparatus which is to be incorporated in a radar transmitter receiver including a transmission antenna which is configured to transmit a transmission signal, a plurality of reception antennas each of which is configured to receive the transmission signal reflected by a target object, and a generator which is configured to generate a plurality of beat signals for each of the receiving antennas and to a radar apparatus comprising the radar transmitter receiver and the signal processing apparatus. Specifically, the present invention relates to a signal processing apparatus and a radar apparatus for detecting the azimuth angle of the target object based on the beat signals.

Recently, for supporting automatic control in a vehicle such as a car, an in-vehicle radar apparatus is used to detect a target object existing around one's own vehicle. And an electronic scanning method is used as a method for detecting the azimuth angle of the target object using the radar apparatus. Patent document 1 discloses an example of a radar apparatus using the electronic scanning method.

According to a radar apparatus using an electronic scanning method, when a radar signal transmitted ahead of the radar apparatus is reflected by the target object, the resultant reflected signals are received as a pair of received signals respectively by a pair of antennas. In this case, since the paired antennas are spaced from each other, the path lengths of the reflected signals from the target object to the respective antennas are different according to the azimuth angles of the target object (here, an angle existing right in front of the radar apparatus is regarded as zero degrees), whereby beat signals obtained by down converting the pair of received signals are different in phase from each other. The electronic scanning type radar apparatus processes the pair of beat signals using a signal processing unit such as a microcomputer and detects the azimuth angle of the target object based on the phase difference between the paired beat signals, the distance between the paired antennas, and the wavelengths of the beat signals.

A digital beam forming (DBF) method is one example of such electronic scanning method. In the DBF method, two or more antennas are arranged spaced at a predetermined distance from each other, a plurality of beat signals respectively obtained by the respective antennas are synthesized, the phase difference between the beat signals is varied to thereby vary the level of the composite amplitude of the beat signals, and an azimuth angle corresponding to the phase difference when the level of the composite amplitude shows the maximum level is detected. Also, the electronic scanning method includes a phase monopulse method in which a phase difference between a pair of beat signals respectively received by two antennas is detected, and an azimuth angle corresponding to the detected phase difference is obtained according to an operation processing, previously stored map data or the like.

Patent Document 1: Japanese Patent Publication 2000-258524 A

In the above-mentioned electronic scanning method, when the path length difference of the paired reflected signals with respect to the antenna distance exceeds the wavelength of the beat signal because the azimuth angle of the target object increases, the phase of the beat signal according to the path length difference can exceed the range of −π˜π, thereby raising a case in which a so called phase repetition phenomenon can be generated. With this case taken into account, assuming that the detected phase difference is provisionally expressed as φ, there is a possibility that the target object can be situated at any one of multiple azimuth angles corresponding to the phase difference φ±2kπ (k=0, 1, 2, . . . ). This raises a problem that the azimuth angle cannot be obtained uniquely from the phase difference of the paired beat signals. In order to solve this problem, there is provided a method in which, by setting the signal receiving surfaces of the antennas in a certain size, the beam width of the receiving signals is limited to an azimuth angle range where the phase repetition phenomenon cannot be generated (which is hereinafter referred to as an azimuth angle detection range). According to this method, a beat signal of an expected level can be obtained from a target object situated within the azimuth angle detection range but a beat signal of an expected level cannot be obtained from a target object situated out of the azimuth angle detection range, whereby the azimuth angle can be detected uniquely from the phase difference φ between a pair of beat signals respectively having an expected level (that is, a phase difference φ obtained where k=0 in the phase difference φ±2kπ).

Recently, it tends to use an electronic scanning type ha-vehicle radar apparatus not only to follow a vehicle moving ahead of the moving lane of one's own vehicle, but also to control one's own vehicle in the following manner: that is, it detects a target object such as an oncoming vehicle in the adjoining traffic lane, a vehicle or a pedestrian crossing in front of one's own vehicle, or a stationary object existing on the traffic lane to thereby avoid a collision with such target object or relieve an impact when one's own vehicle collides with such target object. This makes it necessary for the radar apparatus to be able to detect the target object in a wider azimuth angle range than only when it follows the vehicle moving ahead of one's own vehicle.

In this respect, since the path length difference between the paired reflected signals decreases as the antenna distance narrows, in principle, by narrowing the antenna distance, the azimuth angle detection range can be widened. However, the to the physical size restrictions of the antenna, there is naturally a limit on narrowing the antenna distance. Also, in order that, while narrowing the beam width of the received signal into the widened azimuth angle detection range, there can be obtained a received signal having a certain level or higher, the receiving surface of the antenna must have a certain size. This also makes it difficult to narrow the antenna distance.

### SUMMARY

It is therefore an object of at least one embodiment of the present invention to provide a signal processing apparatus which can widen an azimuth angle detection range even when the paired antennas are spaced from each other by a certain distance.

In order to achieve the above described object, according to a first aspect of at least one embodiment of the present invention, there is provided a signal processing apparatus which is to be incorporated in a radar transmitter receiver including a transmission antenna which is configured to transmit a transmission signal, a plurality of reception antennas each of which is configured to receive the transmission signal reflected by a target object, and a generator which is configured to generate a plurality of beat signals for each of the receiving antennas, the signal processing apparatus comprising: a synthesizer which is configured to synthesize the beat signals to generate a synthesized beat signal; and a detector which is configured to detect an azimuth angle of the target object based on the synthesized beat signal and one of the beat signals.

According to the above aspect, since the beat signals are synthesized each other to generate the synthesized beat signal, it is possible to obtain a synthesized beat signal having the same phase with the beat signal obtained from a virtual antenna which is interposed between a pair of antennas. By detecting the azimuth angle of the target object based on one of the beat signals and the synthesized beat signal, the azimuth angle can be detected based on beat signals respectively obtained by a pair of antennas having a narrower antenna distance than an actual antenna distance, that is, based on beat signals respectively obtained by the virtual antenna and one of the actual antennas. Therefore, an azimuth angle detection range, where a phase repetition phenomenon does not occur, can be widened while the antenna distance is kept rather long.

The detector may detect the azimuth angle of the target object based on a phase difference between the synthesized beat signal and the one of the beat signals. The signal processing apparatus may further comprise a corrector which is configured to correct one of a level of the synthesized beat signal and a level of one of the beat signals such that the level of the synthesized beat signal becomes equal to the level of the one of the beat signals, and the detector may detect the azimuth angle of the target object based on the synthesized beat signal and the one of the beat signals which are made equal to each other in level. The corrector may correct one of the level of the synthesized beat signal and a level of one of the beat signals, which corresponds to the detected azimuth angle such that the level of the synthesized beat signal becomes equal to the level of the one of the beat signals, and the detector may further detect the azimuth angle of the target object based on the synthesized beat signal and the one of the beat signals which are made equal to each other in level. The radar transmitter receiver may be mounted on a mobile object, and the detector may selectively execute a first detection processing for detecting the azimuth angle of the target object based on the synthesized beat signal and one of the beat signals and based on a moving state of the mobile object or a state of the target object and a second detection processing for detecting the azimuth angle of the target object based on the beat signals.

According to a second aspect of at least one embodiment of the present invention, there is provided a radar apparatus, comprising the radar transmitter receiver and the signal processing apparatus described above.

### BRIEF DESCRIPTION OF THE DRAWINGS

The above objects and advantages of the present invention will become more apparent by describing in detail preferred exemplary embodiments thereof with reference to the accompanying drawings, wherein;

FIG. 1 is a schematic view illustrating a usage state of a radar apparatus according to embodiments of the invention;

FIG. 2 is a schematic view illustrating a configuration of a radar apparatus 10 according to a first embodiment of the invention;

FIGS. 3A and 3B are explanatory views illustrating variations in the frequencies of a transmission signal and one of received signals according to the first embodiment;

FIG. 4 is a flow chart of a main operation procedure carried out by a signal processing apparatus 14 according to the first embodiment;

FIGS. 5A and 5B are explanatory views illustrating an azimuth angle detection principle in an electronic scanning method;

FIG. 6 is an explanatory view illustrating an antenna pattern of receiving antennas;

FIGS. 7A and 7B are explanatory views illustrating a DBF processing;

FIGS. 8A and 8B are an explanatory view illustrating a method for widening an azimuth angle detection range according to the first embodiment;

FIG. 9 is a flow chart of an azimuth angle detection procedure according to the first embodiment;

FIGS. 10A to 10C are explanatory views illustrating a first modification of the first embodiment;

FIGS. 11A and 11B are explanatory views illustrating a second modification of the first embodiment;

FIG. 12 is a flow chart of the operation procedure of the signal processing apparatus 14 according to the first and second modifications;

FIG. 13 is a schematic view illustrating a configuration of a radar apparatus 10 according to a second embodiment of the invention;

FIG. 14 is a flow chart of a main operation procedure carried out by a signal processing apparatus 14 according to the second embodiment;

FIGS. 15A and 15B are examples of map data illustrating a correspondence relationship between phase differences and azimuth angles;

FIG. 16 is an example of map data according to the second embodiment;

FIG. 17 is an explanatory view illustrating effects of the embodiments;

FIG. 18 is a flow chart of an azimuth angle detection procedure according to the second embodiment; and

FIG. 19 is a flow chart of an operation procedure of the signal processing apparatus 14 according to the first and second embodiments.

### DETAILED DESCRIPTION OF THE EMBODIMENTS

Embodiments of the invention will be described with reference to the accompanying drawings. The scope of the invention is not limited to these embodiments and includes the scope of the appended patent claims and their equivalents.

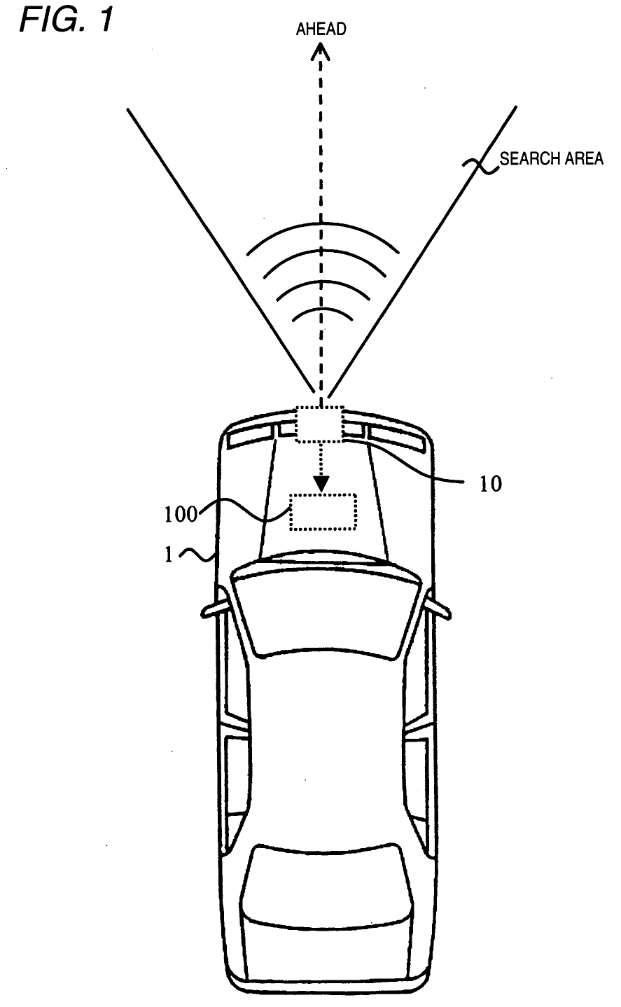

FIG. 1 is a schematic view illustrating a usage state of a radar apparatus according to the embodiments. A radar apparatus 10 of an electronic scanning type, in an exemplary case, is mounted on the forward front grille or bumper of a vehicle 1 and is used to transmit a radar signal (an electromagnetic wave) to a search area in front of the vehicle 1 and receive reflected signals from the search area with multiple antennas. And, the radar apparatus 10 generates beat signals for each antenna and processes these beat signals using a signal processing apparatus such as a microcomputer to thereby detect the azimuth angle, relative distance and relative velocity of a target object existing in the search area. Here, the target object includes, for example, a vehicle moving ahead of the vehicle 1, an oncoming vehicle, a pedestrian or a stationary object existing on a traffic lane.

And, a vehicle control apparatus 100 drives the actuator of the vehicle 1 according to the detection results of the radar apparatus 10 to thereby control the behavior of the vehicle 1. For example, while following a vehicle moving ahead of the vehicle 1 using the radar apparatus 10, the vehicle control apparatus 100 allows the vehicle 1 to follow the vehicle moving ahead of it with a predetermined distance between them; and, the vehicle control apparatus 100 determines the degree of the probability of the collision of the vehicle 1 with the target object according to the relative speed or relative distance of the target object, and, when the vehicle 1 is predicted to collide with the target object, the apparatus 100 can control the vehicle 1 to avoid such collision, or it can operate a warning device or an occupant protect device.

By the way, the state illustrated here is just an example. That is, the radar apparatus 10 may also be mounted on the side front portion, side portion, rear portion or side rear portion of the vehicle 1 and thus may be used to detect a target object in a search area which exists laterally forwardly, laterally, backwardly or laterally backwardly of the vehicle.

Also, in the following description, an example in which the radar apparatus 10 is mounted on a vehicle will be described; however, alternatively, the radar apparatus 10 can also be mounted on the other mobile object such as an aircraft or a ship.

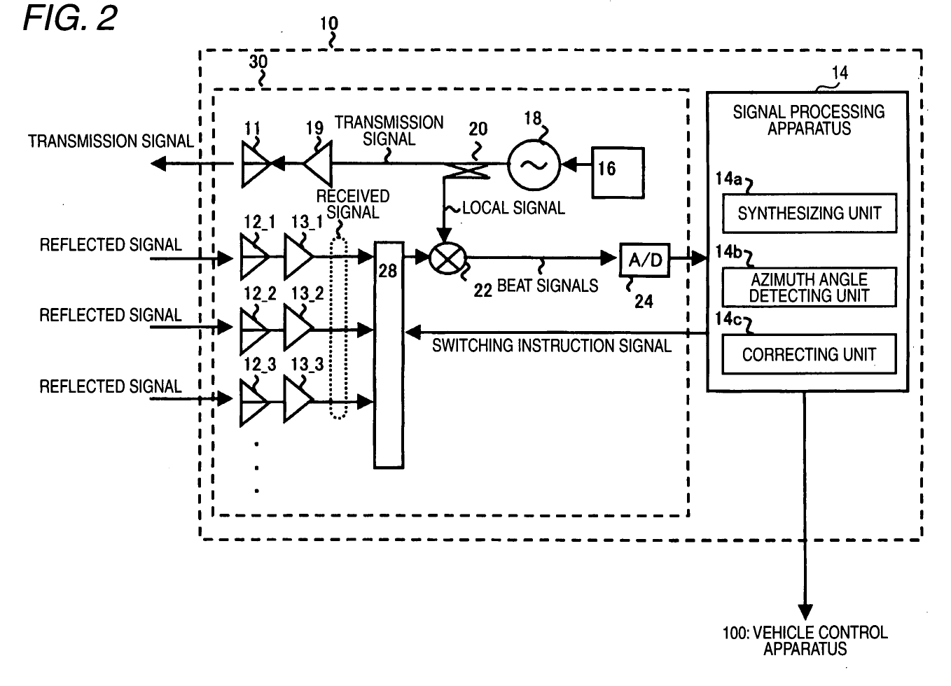

FIG. 2 is a schematic view illustrating a configuration of a radar apparatus 10 according to a first embodiment of the invention. Here, the radar apparatus 10 is a radar apparatus employing a DBF method which is one of the electronic scanning methods. Also, the radar apparatus 10 uses, together with the DBF method, an FM-CW (Frequency Modulated-Continuous Wave) method for transmitting and receiving, as a radar signal, a continuous wave with the frequency thereof modulated.

The radar apparatus 10 includes: a radar transmitter receiver 30 which generates a radar signal, transmits it from a transmitting antenna 11 and receives reflected signals from a target object using multiple receiving antennas 12_1, 12_2, 12_3, . . . , and also which, after then, generates a plurality of beat signals from the thus received signals; and, a signal processing apparatus 14 for processing the beat signals.

In the radar transmitter receiver 30, a modulation signal generator 16 generates a modulation signal having a triangular wave shape; and, a voltage control oscillator (VCO) 18 outputs, as a radar signal, a continuous wave (an electromagnetic wave) of a millimeter wavelength the frequency of which increases gradually in the rising block of the triangular wave and decreases gradually in the lowering block of the triangular wave. Also, when a distributor 20 power distributes the radar signal to a transmission signal and a local signal, the transmission signal is amplified by an amplifier 19 and is transmitted from the transmitting antenna 11. When this transmission signal is reflected by a target object, the reflected signals are received as received signals respectively by the receiving antennas 12_1, 12_2 and 12_3 arranged at arbitrary intervals. The received signals are respectively amplified by their associated amplifiers 13_1, 13_2 and 13_3 and are then input to a switch circuit 28. Here, for convenience of explanation, there is illustrated a structure which includes three receiving antennas; however, the number of antennas may also be two, or, four or more.

The switch circuit 28, in response to a switching instruction signal from the signal processing apparatus 14, inputs the received signals every antennas 12_1, 12_2 and 12_3 into a mixer 22 in a time-sharing manner. On the other hand, the local signal, which is power distributed by the distributor 20, is also input to the mixer 22. The mixer 22 mixes together the local signal and the respective received signals and outputs a plurality of beat signals the frequency each having a frequency which corresponds to a frequency difference between the local signal and the respective received signals, that is, a frequency difference between the transmission signal and the respective received signals. Here, the received signals having a millimeter wavelength are down converted to beat signals having an intermediate frequency.

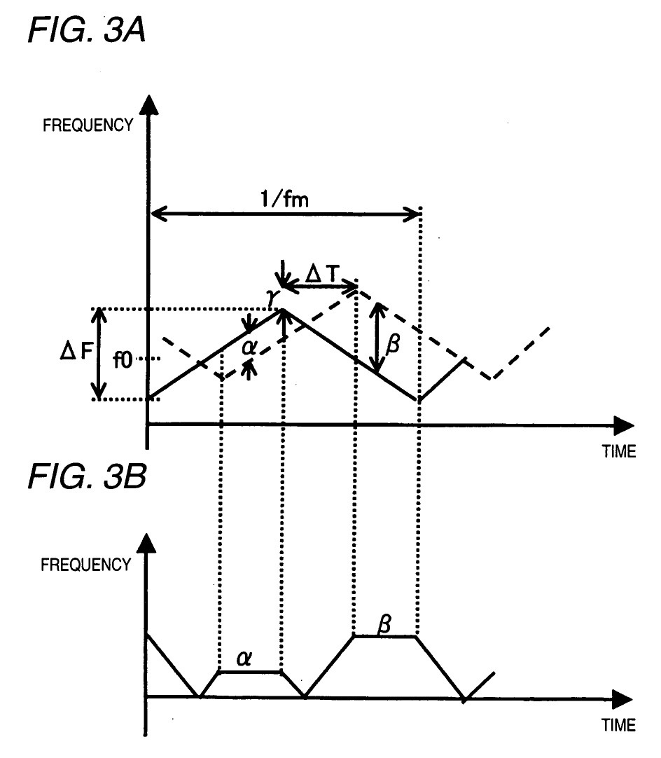

FIG. 3A illustrates variations in the frequency of the transmission signal and in the frequency of one of the received signals. The frequency of the transmission signal, as shown by a solid line, rises and lowers linearly with its center frequency f0 (for example, 76.5 GHz) and its frequency modulation width a (for example, 200 MHz) according to a frequency modulation signal of a triangular wave having a frequency fm (for example, 400 Hz). Here, a pair of frequency rising period (up period) and frequency falling period (down period) correspond to one modulation cycle. On the other hand, the frequency of the received signal, as shown by a broken line, is influenced by: a time delay ΔT caused by the relative distance of the target object that has reflected the received signal; and, a deviation of a Doppler frequency γ corresponding to the relative velocity of the target object. As a result of this, between the transmission and received signals, there are generated a frequency difference a in the up period and a frequency difference β in the down period. Thus, the frequency (beat frequency) of a beat signal having a frequency corresponding to the frequency difference between them, as shown in FIG. 3B, provides a beat frequency a in the up period and a beat frequency β in the down period. And, in the beat frequencies α, β, the relative distance R of the target object, and the relative velocity V of the target object, the following relationships hold, where C expresses the velocity of light.

R=C·(α+β)/(8·ΔF·fm) Expression (1)

V=C·(β−α)/(4·f0) Expression (2)

Referring back to FIG. 2, the above-mentioned beat signals are respectively sampled and converted by an A/D converter 24 to digital data, and such digital data are then input to the signal processing apparatus 14. At the then time, into the signal processing apparatus 14, there are input digital data on the beat signals which, due to the operation of the switch circuit 28, are generated substantially at the same time from the received signals received simultaneously by the antennas 12_1, 12_2 and 12_3.

The signal processing apparatus 14 includes: a well known microcomputer having a CPU (Central Processing Unit), a ROM (Read Only Memory) and a RAM (Random Access Memory); and further, an operation processing unit (for example, a DSP: Digital Signal Processor) for carrying out a fast Fourier transform processing (FFT processing) on the digital data on the beat signals.

The signal processing apparatus 14 includes: a synthesizing unit 14a for synthesizing the paired beat signals of the plurality of beat signals obtained from the mutually adjoining paired antennas to thereby generate a synthesized beat signal; an azimuth angle detecting unit 14b for carrying out a DBF processing on the beat signals including the synthesized beat signal to thereby detect an azimuth angle where a target object is situated; and, a correcting unit 14c for correcting the levels of the beat signals or synthesized beat signals according to a method which will be discussed later in detail. The synthesizing unit 14a, azimuth angle detecting unit 14b and correcting unit 14e each includes a program stating operation procedures to be discussed later in detail and a CPU to be operated according to the program. The signal processing apparatus 14 further processes the beat signals according to procedures to be discussed below to thereby detect the relative distance and relative velocity of the target object, and outputs the detected azimuth angle, relative distance and relative velocity of the target object to the vehicle control apparatus 100.

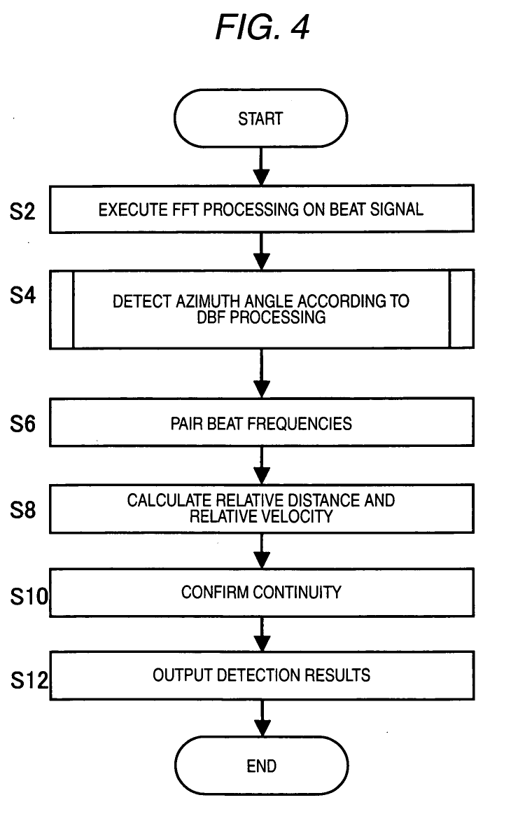

FIG. 4 is a flow chart of a main operation procedure carried out by a signal processing apparatus 14 according to the first embodiment. The procedure shown in FIG. 4 is carried out every one modulation cycle of a transmission signal. Firstly, the signal processing apparatus 14 carries out an FFT processing on each of the beat signals in every up period and down period to detect the frequency spectra thereof, and, detects a beat frequency in which the detected frequency spectra form a peak (S2). And, the signal processing apparatus 14, using the beat signals having the peak forming beat frequency, carries out a DBF processing to thereby detect the azimuth angle of the target object (S4).

Next, the signal processing apparatus 14 pairs together the beat frequencies which coincide with each other in the beat signal level and in the detected azimuth angle, of the beat frequencies detected in the up and down periods (S6), and detects the relative distance and relative velocity of the target object according to the above-mentioned expressions (1) and (2) (S8). Then, the signal processing apparatus 14 confirms whether the detected results have continuity in the multiple past detected cycles or not (S10), and outputs the detected results, in which a certain level of historical connection has been confirmed, to the vehicle control apparatus 100 (S12).

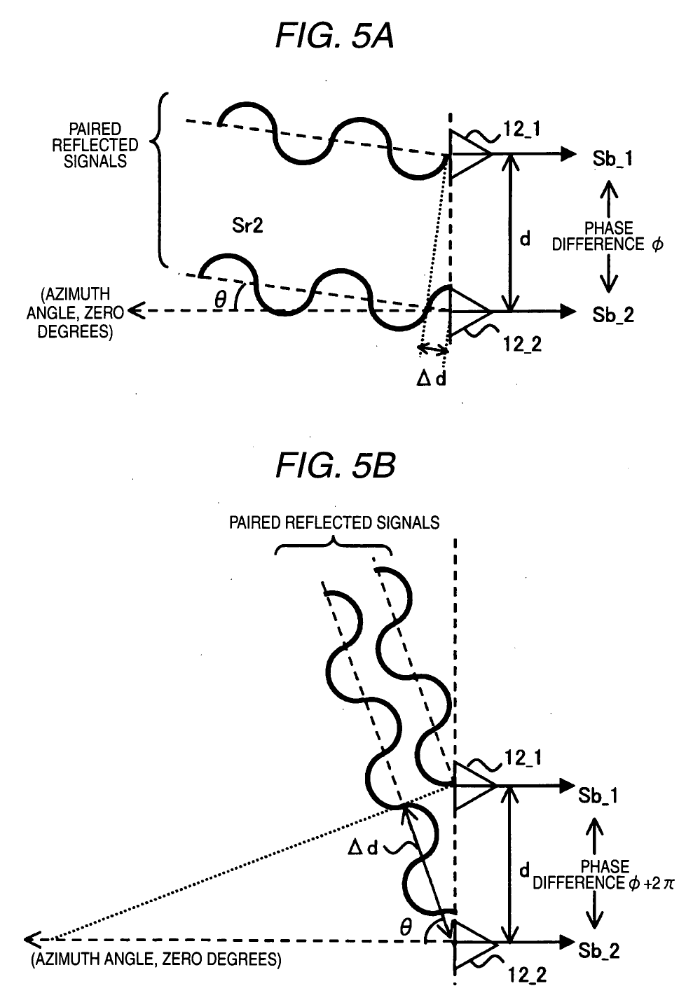

Here, description will be given below in detail of an azimuth angle detecting method used in the above-mentioned step S4. Firstly, for convenience of explanation, description will be given of an azimuth angle detecting principle in a general electronic scanning method with reference to FIGS. 5A and 5B. In FIG. 5A, there is shown an example in which reflected signals coming from the target object situated at an azimuth angle θ (which is to be other angle than zero degrees) are received by the antennas 12_1 and 12_2. Here, suppose the paths of the paired reflected signals are parallel to each other, there is generated a path length difference Δd (=d·sin θ) in proportion to the antenna distance d. Due to this, the time for the paired reflected signals to arrive at the antenna 12_2 is delayed by an amount equivalent to the path length difference Δd. Therefore, where the wavelengths of the beat signals Sb_1 and Sb_2 obtained by down converting the paired received signals are expressed as λ, between the beat signals Sb_1 and Sb_2, there is generated a phase difference φ (=Δd·2π/γ) corresponding to the difference between their receiving times. Thus, in the phase difference φ between the paired beat signals and the azimuth angle θ of the target object, the following relationship holds.

That is, θ=arcsin(π·φ)/(2π·d) Expression (3).

Here, when the azimuth angle θ increases, the path length difference Δd between the paired reflected signals increases as shown in FIG. 5E, the phase of the beat signal Sb_2 in the received time difference exceeds 2π, thereby raising a possibility that a so called phase repetition phenomenon can occur. When such phase repetition occurs, in the phase difference φ between the beat signals Sb_1, Sb_2 and the azimuth angle θ, there holds the following relationship, with the result that the azimuth angle θ cannot be specified uniquely from the phase difference φ.

θ=arcsin(φ·±2kπ)/(2π·d))(k=0, 1, 2, . . . ) Expression (4).

Here, since the phase difference φ is detected in the range of −π□φ□π, the azimuth, angle detection range, where no phase repetition occurs, can be expressed in the following manner according to the above-mentioned expression (4).

−arcsin(λ(2d))<θ<arcsin(λ/(2d)) Expression (5).

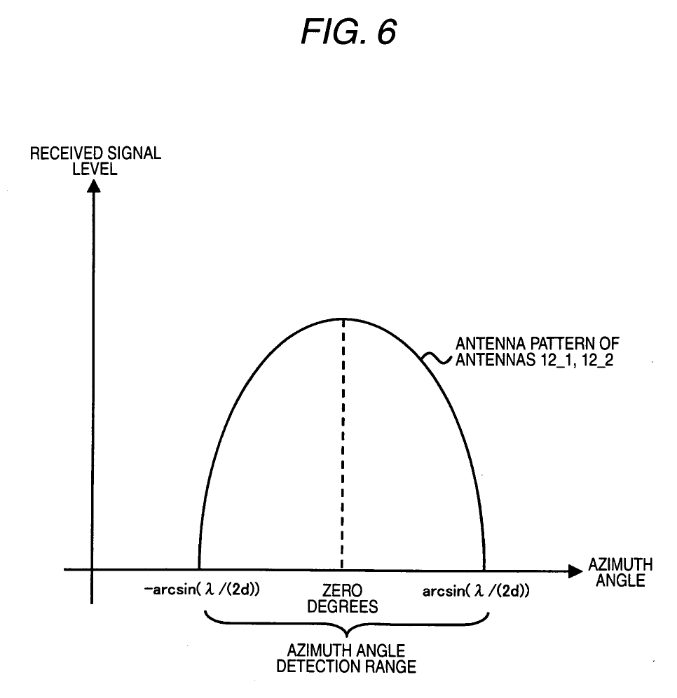

Here, in order to detect the azimuth angle uniquely from the phase difference in the azimuth angle detection range expressed by the above expression (5), the respective beam widths of the paired received signals respectively received by the antennas 12_1 and 12_2 are limited within, the above-mentioned azimuth angle detection range. That is, the antennas 12_1 and 12_2 are respectively made of an antenna having such an antenna pattern as shown in FIG. 6. In this case, from a target object situated within the azimuth angle detection range, there can be obtained a beat signal having an expected level; but, from a target object situated out of the azimuth angle detection range, there cannot be obtained a beat signal having an expected level. Therefore, when there are obtained a pair of beat signals each having an expected level, based on the phase difference φ thereof, the azimuth angle θ can be detected uniquely within the range of the expression (5) according to the expression (3).

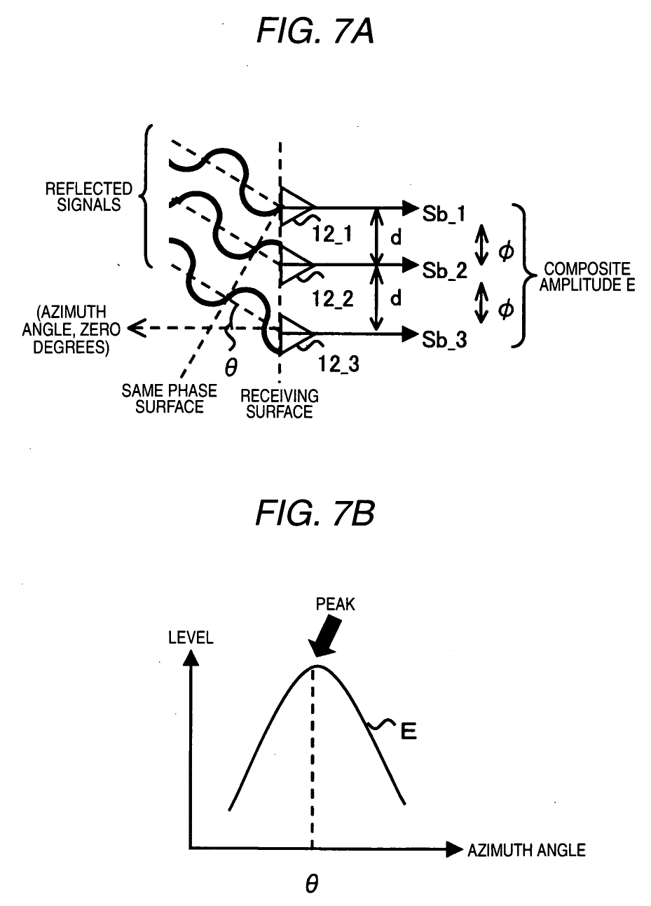

Next, description will be given below of the DBF processing for detecting the azimuth angle of a target object in the above-mentioned azimuth angle detection range with reference to FIGS. 7A and 7B. As shown in FIG. 7A, when the reflected signals coming from the azimuth angle θ are received by the antennas 12_1, 12_2 and 12_2, since the received signals have a phase difference in the receiving surfaces of the antennas, the amplitudes of the received signals cancel each other; whereas, in the surfaces (the same phase surfaces) thereof perpendicular to the azimuth angle θ, since the received signals are in phase with each other, the level of the synthesized amplitude thereof provides the maximum. That is, since, in the beat signals Sb_1, Sb_2 and Sb_3, there is generated an equal phase difference φ between the mutually adjoining beat signals, the amplitudes thereof cancel each other; however, by applying, as an offset, such a phase difference as cancels the phase difference φ the beat signals Sb_1, Sb_2 and Sb_3 can be made to be in phase with each other, whereby the level of the composite amplitude of the beat signals can be made the maximum level. In other words, at the then time, the directivity of the antennas 12_1, 12_2 and 12_3 coincides with the azimuth angle θ.

Thus, in the DBF processing, while applying an arbitrary phase difference to the mutually adjoining paired beat signals, the composite amplitude of the beat signals Sb_1, Sb_2 and Sb_3 is calculated and, by specifying the phase difference φ that can provide the maximum level of the composite amplitude, the azimuth angle θ corresponding to such specified phase difference φ can be detected.

Specifically, the azimuth angle detecting unit 14b, according to digital calculation and using the expression (3), derives the composite amplitude E of the beat signals Sbₐ1, Sb_2 and Sb_3 as a function having an azimuth angle as a parameter. And, as shown in FIG. 7B, the unit 14b calculates the level of the composite amplitude E in the azimuth angle direction and detects au azimuth angle θ when the peak of the level is formed.

Here, description will be given below of a method for widening the azimuth angle detection range expressed by the expression (5) in the first embodiment.

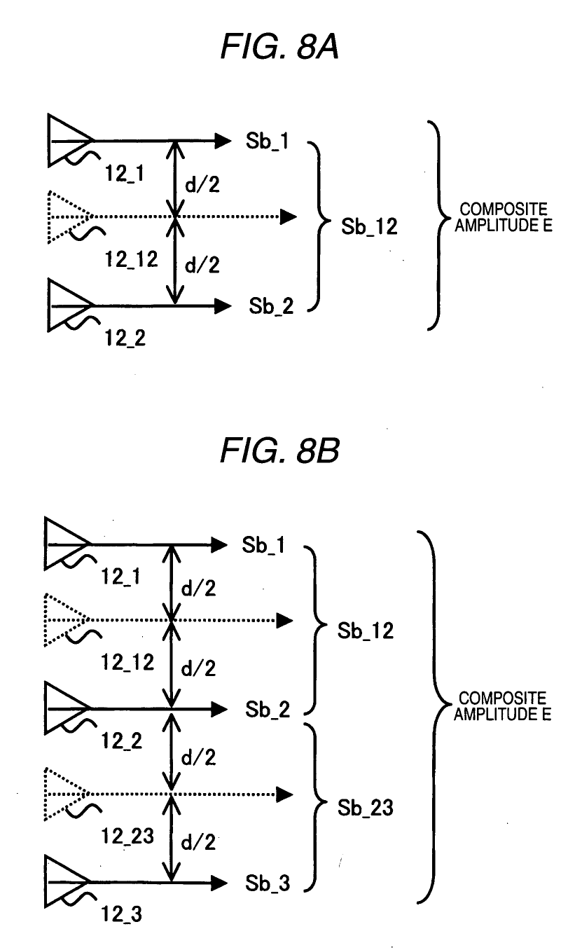

FIGS. 8A and 8B are an explanatory view illustrating a method for widening an azimuth angle detection range by the expression (5) according to the first embodiment. Firstly, FIG. 8A illustrates the beat signals Sb_1 and Sb_2 which are generated from a pair of received signals respectively received by the antennas 12_1 and 12_2. The synthesizing unit 14a of the signal processing apparatus 14 firstly synthesizes the beat signals Sb_1 and Sb_2 according to digital operation to generate a synthesized beat signal Sb_12. Here, the synthesized beat signal Sb_12 is a signal which has the same frequency as the beat signals Sb_1 and Sb_2 and the maximum amplitude of which is equal to the sum of the maximum amplitudes of the beat signals Sb_1 and Sb_2. And, the phase difference between the beat signal Sb_1 and synthesized signal Sb_12 as well as the phase difference between the synthesized signal Sb_12 and beat signal Sb_2 are respectively one half the phase difference between the beat signals Sb_1 and Sb_2. That is, suppose a virtual antenna 12_12 is situated between the antennas 12_1 and 12_2, the synthesized beat signal Sb_12 has the same phase as a beat signal which is generated from a received signal received by the virtual antenna 12_12.

Here, when there is carried out such a DBF processing as mentioned above using the beat signals Sb_1 and Sb_2 as well as the synthesized beat signal Sb_12, it is possible to detect an azimuth angle which is based on the phase difference between the beat signals Sb_1 and Sb_12 respectively received by the antenna 12_1 and virtual antenna 12_12 as well as on the phase difference between the beat signals Sb_12 and Sb_2 respectively received by the virtual antenna 12_12 and antenna 12_2. That is, there can be obtained the same result as a ease where a DBF processing is carried out using beat signals respectively obtained by a pair of antennas the antenna distance of which is narrower than the antenna distance between the actual antennas 12_1 and 12_2. This corresponds to a case where d/2 is used instead of the antenna distance d in the expression (5). Therefore, the azimuth angle detection range can be widened.

Here, although description has been given above of the azimuth angle detection range widening processing using the antennas 12_1 and 12_2 for convenience of explanation, this processing can also be applied to a pair of beat signals respectively received by the mutually adjoining antennas 12_2 and 12_3. In doing so, as shown in FIG. 5B, there can be obtained the same result as a ease where a DBF processing is carried out using the beat signals Sb_1, Sb_2 and Sb_3 respectively received by the antennas 12_1, 12_2 and 12_3 as well as the synthesized beat signals Sb_12 and Sb_23 respectively received by the virtual antennas 12_12 and 12_23.

That is, according to the first embodiment, the arrangement of three antennas can realize a structure equivalent to the arrangement of five antennas. Owing to this, since the azimuth angle detection range can be widened and also a DBF processing can be carried out using a larger number of beat signals, the amount of variations in the level of the composite amplitudes of beat signals in an azimuth angle direction can be made steep. Thus, the azimuth angle resolving power can be enhanced.

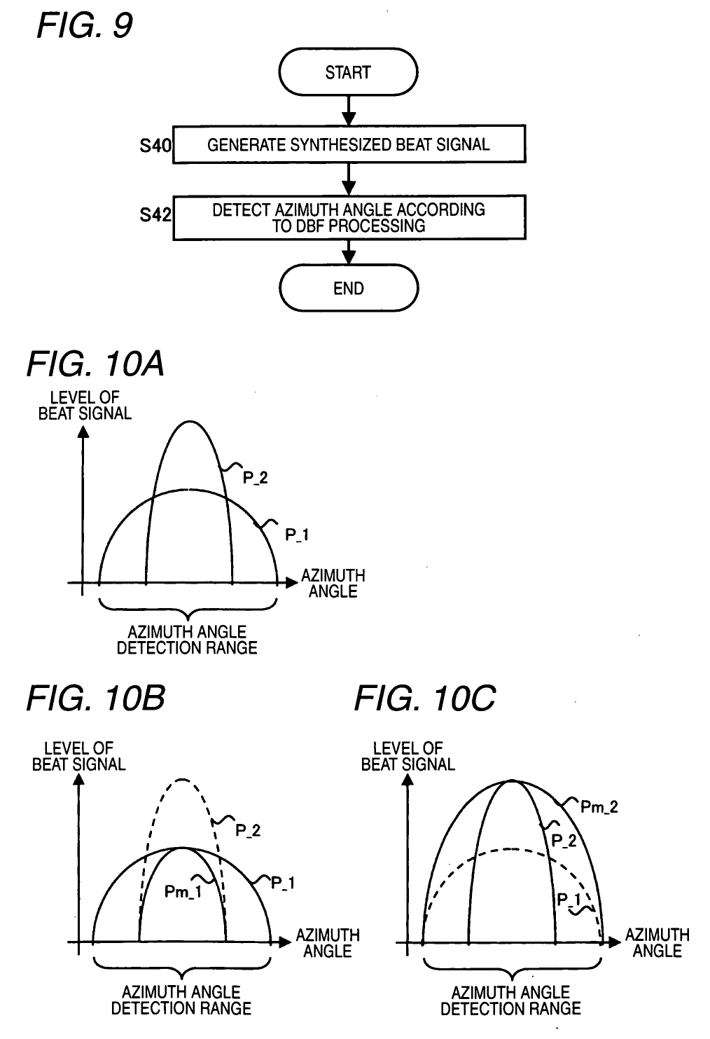

FIG. 9 is a flow chart of an azimuth angle detection procedure according to the first embodiment. The procedure shown in FIG. 9 corresponds to the subroutine of the step S4 shown in FIG. 4. Firstly, the synthesizing unit 14a synthesizes a pair of beat signals respectively received by every pair of mutually adjoining antennas to generate synthesized beat signals (S40). Next, the azimuth angle detecting unit 14b carries out the above-mentioned DBF processing on all of beat signals including the synthesized beat signals to detect the azimuth angle θ of a target object (S42). According to such procedure, the azimuth angle detection range can be widened without changing the physical antenna distance.

Next, description will be given below of a modification of the first embodiment. As described above, the level of the maximum amplitude of the synthesized beat signal Sb_12 or Sb_23 is equal to the sum of the maximum amplitudes of the synthesized beat signals Sb_1 and Sb_2 or beat signals Sb_2 and Sb_3.

This is shown in FIG. 10A. When the level P_1 of the maximum amplitude with respect to the azimuth angle in the beat signals Sb_1, Sb_2 and Sb_3 is compared with the level P_2 of the maximum amplitude with respect to the azimuth angle in the synthesized beat signals Sb_12 and Sb_23, the level P_2 is higher than the level P_1 in the central portion of the azimuth angle detection range, whereas the level P_1 is higher than the level P_2 in the end portions of the azimuth angle detection range. In this case, when detecting the maximum value of the level of the composite amplitude E according to the DBF processing, the beat signals Sb_1, Sb_2 and Sb_3 are not uniform in level with the synthesized beat signals Sb_12 and Sb_23. This gives rise to the generation of the azimuth, angle detection error.

In view of this, according to the present modification, there is carried out such a correcting processing as allows the beat signals Sb_1, Sb_2 and Sb_3 to be uniform in level with the synthesized beat signals Sb_12 and Sb_23. For example, as shown in FIG. 10B, the level P_2 of the synthesized beat signals Sb_12 and Sb_23 is corrected to, for example, Pm_1. Referring to a specific correcting method, the level of the synthesized beat signals Sb_12 and Sb_23 is multiplied by a predetermined correction coefficient (for example, one half) to correct the level. Or, as shown in FIG. 10C, the level P_1 of the beat signals Sb_1, Sb_2 and Sb_3 is corrected to, for example, Pm_2. Specifically, the level of the beat signals Sb_1, Sb_2 and Sb_3 is multiplied by a predetermined correction coefficient (for example, 2).

Since, as described above, the DBF processing is carried out on the beat signals Sb_1, Sb_2 and Sb_3 as well as on the synthesized beat signals Sb_12 and Sb_23 in a state where they are equal in level to each other, the detection error of the azimuth angle can be prevented.

Here, even when the above correction is made, in the end portions of the azimuth angle detection range, the level difference between the beat signals Sb_1, Sb_2, Sb_3 and the synthesized beat signals Sb_12, Sb_23 is large. Thus, when a target object is actually situated in the end portions of the azimuth angle detection range, since the synthesized beat signals Sb_12, Sb_23 is lower in level than the beat signals Sb_1, Sb_2, Sb_3, in the level of the composite amplitude of the beat signals, a proper peak cannot be formed, thereby raising a fear that the omission or error of the azimuth angle detection can be made.

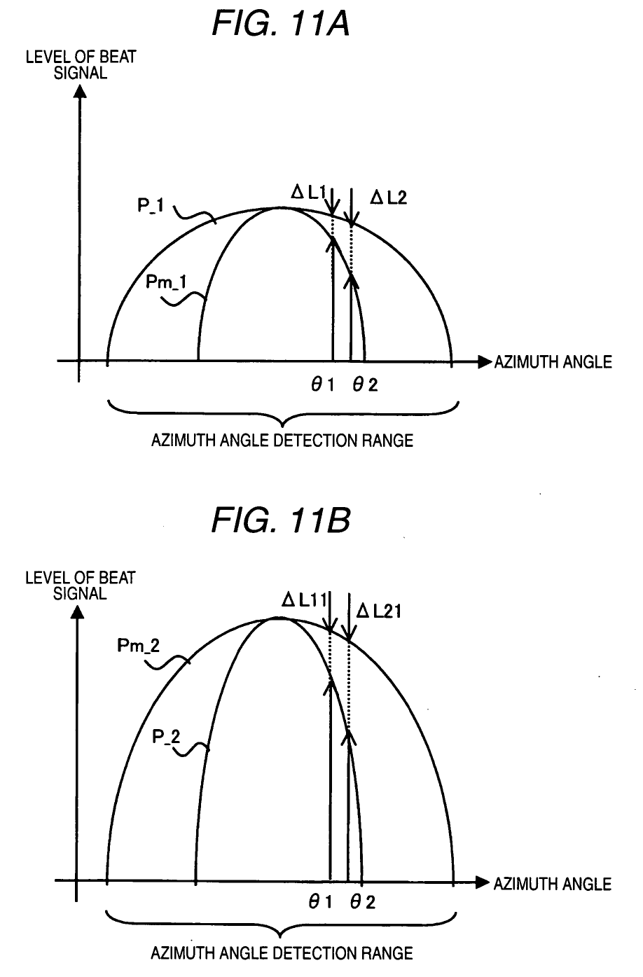

In view of this, as a second modification of the first embodiment, when an azimuth angle detected in the last time detection cycle exists in the end portions of the azimuth angle detection range, the level of the synthesized beat signals Sb_12, Sb_23 or the level of the beat signals Sb_1, Sb_2, Sb_3 is corrected again. Specifically, as shown in FIG. 11A, a difference between the after-corrected level Pm_1 of the synthesized beat signals Sb_12, Sb_23 and the after-corrected level P_1 of the beat signals Sb_1, Sb_2, Sb_3 is previously stored for every predetermined azimuth, angle in a ROM as a correction value (for example, for the last time detected azimuth angle θ1, a correction value ΔL1 and, for the last time detected azimuth angle θ2, a correction value ΔL2); and, a correction value corresponding to the azimuth angle detected last time is read out from the ROM and is added to the level of the synthesized beat signals Sb_12, Sb_23.

Or, as shown in FIG. 11B, a difference between the after-corrected level Pm_2 of the beat signals Sb_1, Sb_2, Sb_3 and the after-corrected level P_2 of the synthesized beat signals Sb_12, Sb_23 is previously stored for every predetermined azimuth angle in a ROM as a correction value (for example, for the last time detected azimuth angle θ1, a correction value ΔL11 and, for the last time detected azimuth angle θ2, a correction value ΔL21); and, a correction value corresponding to the azimuth angle detected last time is read out from the ROM and is subtracted from the level of the beat signals Sb_1, Sb_2, Sb_3.

And, using the thus corrected the beat signals Sb_1, Sb_2, Sb_3 and synthesized beat signals Sb_12, Sb_23, the DBF processing is carried out to thereby detect the azimuth angle again. Owing to this, since a composite amplitude corresponding to the last time detected azimuth angle is easy to form a peak, there can be reduced the fear of the omission or error of the azimuth angle detection being made.

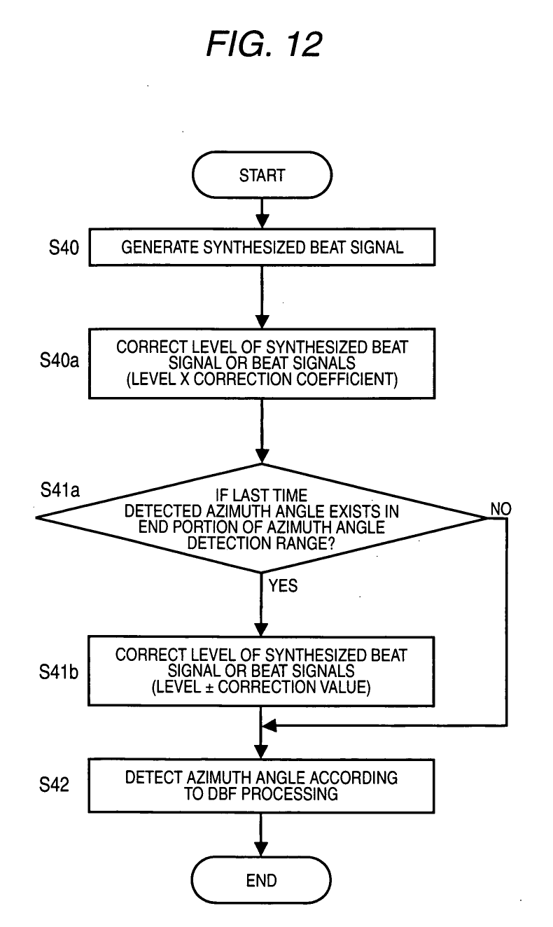

FIG. 12 is a flow chart of the operation procedure of the signal processing apparatus 14 according to the first and second modifications. The procedure shown in FIG. 12 is a modified version of the procedure shown in the flow chart of FIG. 9. That is, when the synthesizing unit 14a generates a synthesized beat signal (S40), the correcting unit 14c multiplies the level of the synthesized beat signal or beat signal by a predetermined correction coefficient (S40a). And, when an azimuth angle detected in the last detection cycle exists in the end portions of the azimuth angle detection range (in S41a, yes), the correcting unit 14c adds a correction value corresponding to the last time detected azimuth angle to the level of the after-corrected synthesized beat signal or beat signal, or subtracts such correction value from such level, thereby carrying out a correcting operation again (S41b). And, the azimuth angle detecting unit 14b carries out a DBF processing using the re-corrected synthesized beat signal and beat signals to thereby detect an azimuth angle (S42).

According to such procedures, it is possible to prevent the omission or error of the azimuth angle detection caused by the fact that the maximum amplitude of the synthesized beat signals Sb_12, Sb_23 is larger than the maximum amplitude of the beat signals Sb_1, Sb_2, Sb_3. That is, it is possible to enhance the azimuth angle detection accuracy when the azimuth angle detection range is widened.

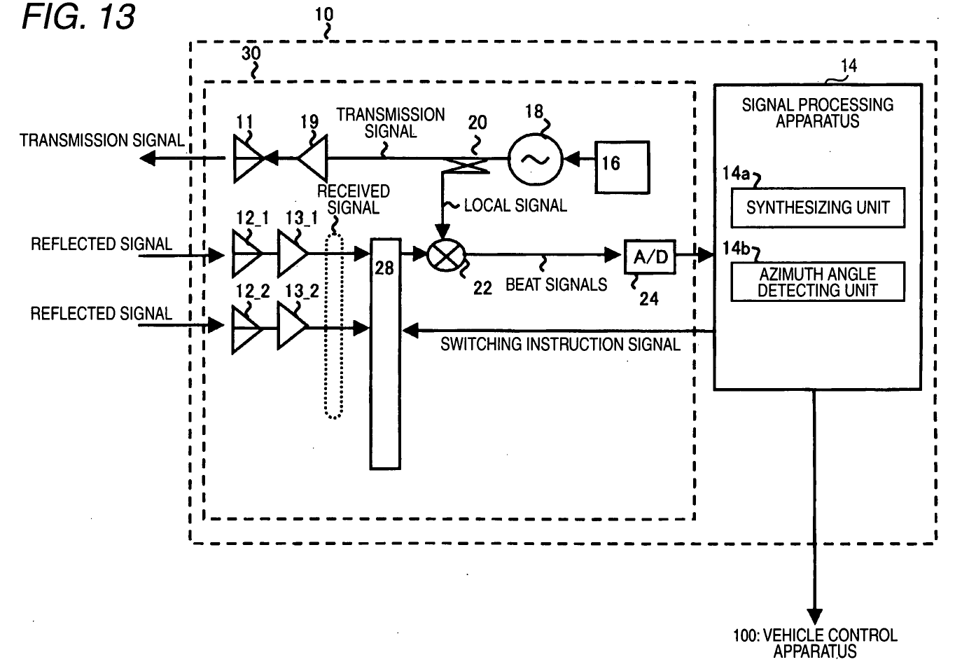

FIG. 13 is a schematic view illustrating a configuration of a radar apparatus 10 according to a second embodiment. According to the second embodiment, the radar apparatus 10 is a radar apparatus which employs a phase monopulse method included in the electronic scanning method. Description will be given below of the portions of the second embodiment that are different from the first embodiment.

Here, a radar transmitter receiver 30 receives reflected signals from a target object using two receiving antennas 12_1 and 12_2, and generates a pair of beat signals from the respective reflected signals. And, the signal processing apparatus 14 includes: a synthesizing unit 14a for synthesizing the paired beat signals to generate a synthesized beat signal; and, an azimuth angle detecting unit 14b for detecting the azimuth angle of the target object according to a phase monopulse method using the paired beat signals and synthesized beat signal.

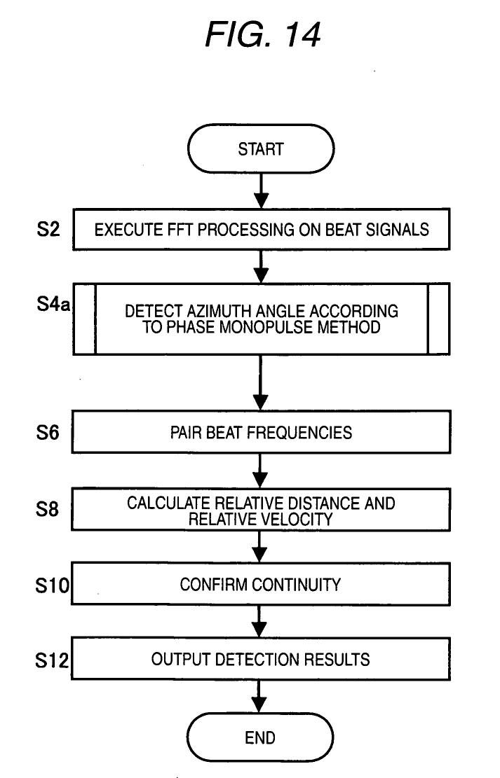

FIG. 14 is a flow chart of a main operation procedure carried out by a signal processing apparatus 14 according to the second embodiment. This flow chart is different from the first embodiment in that a step S4a is executed instead of the step S4 included in the procedure to be executed according the first embodiment. That is, the azimuth angle detecting unit 14b detects an azimuth angle using the paired beat signals according to the phase monopulse method (S4a).

Here, description will be given below of an azimuth angle detecting method used in the step S4a. According to the phase monopulse method, the azimuth angle detecting unit 14b detects the phase difference φ between the paired beat signals shown in FIG. 5A from the FFT results and, according to the phase difference φ, detects the azimuth angle θ using the expression (3). In this case, an operation processing for calculating the expression (3) may be carried out; or, map data, in which the azimuth angle θ is made to correspond to the phase difference φ, may be previously stored in a ROM, and the azimuth angle θ may be detected by reading the azimuth angle θ corresponding to the phase difference φ.

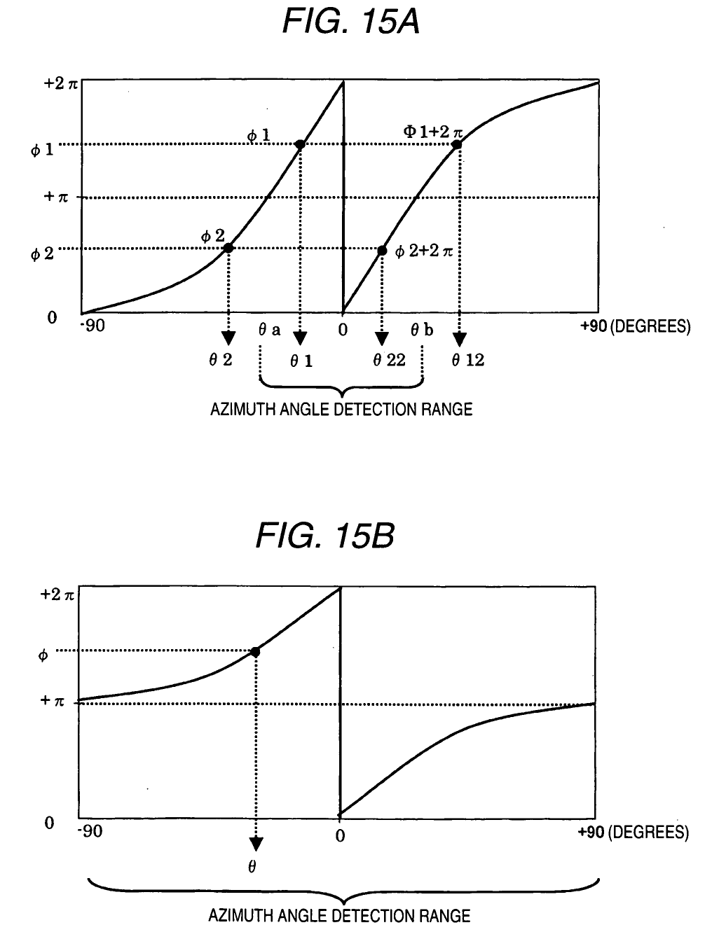

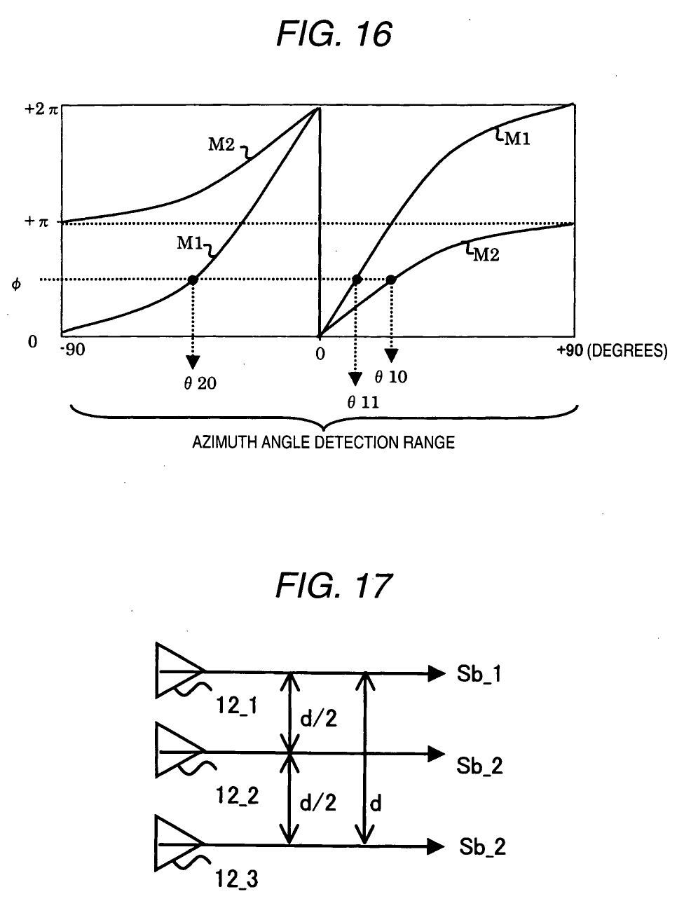

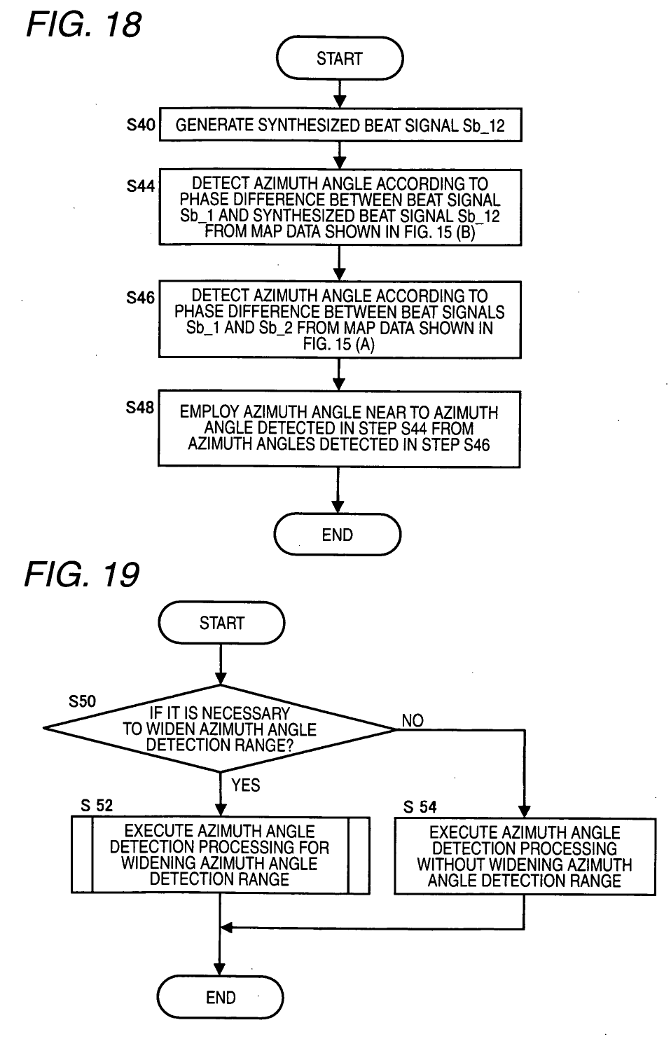

FIGS. 15A and 15B are examples of map data illustrating a correspondence relationship between phase differences and azimuth angles. The map data in FIG. 15A shows the correspondence relationship between the phase differences (vertical axis) and azimuth angles (horizontal axis) of a pair of beat signals where the antenna distance d between the antennas 12_1 and 12_2 is set for the 1 wavelength λ, of the paired beat signals. Here, an azimuth angle range θa˜θb, where no phase repetition is generated, is an azimuth angle detection range. In this case, as shown in FIG. 15A, from a phase difference φ1, due to generation of the phase repetition at an azimuth angle θb, there can be obtained multiple azimuth angles, that is, an azimuth angle θ1 corresponding to the phase difference φ1 and an azimuth angle θ12 corresponding to a phase difference φ1+2π; and, from a phase difference φ2, due to generation of the phase repetition at an azimuth angle θa, there can be obtained multiple azimuth angles, that is, an azimuth angle θ2 corresponding to the phase difference φ2 and an azimuth angle θ22 corresponding to a phase difference φ2+2π. Therefore, the azimuth angle cannot be obtained uniquely from the phase difference. In this case, when the beam width of the paired received signals in the antennas 12_1 and 12_2 is limited within the azimuth angle detection range (θa˜θh), in the azimuth angle detection range, the azimuth angle θ can be detected uniquely from the phase difference φ.

Here, in the second embodiment, using the following method, the above-mentioned azimuth angle detection range is widened. That is, as already shown in FIG. 8A, the synthesizing unit 14a of the signal processing apparatus 14, with a digital operation, synthesizes the beat signals Sb_1 and Sb_2 generated from the paired received signals respectively received by the antennas 12_1 and 12_2, thereby generating the synthesized beat signal Sb_12. In this case, the synthesized beat signal Sb_12 has the same phase as a beat signal generated from a received signal received by the virtual antenna 12_12 situated between the antennas 12_1 and 12_2; and, at the then time, the distance between the antenna 12_1 or 12_2 and virtual antenna 12_12 provides d/2, that is, one half the wavelength λ of the beat signal.

In this case, since d/2 is used instead of the antenna distance d in the expression (5) and also since d/2 is equal to λ/2 (d/2=λ/2), the azimuth angle detection range can be widened up to the range of −90 degrees˜+90 degrees. Thus, in the map data of FIG. 15B in which the range of −90 degrees˜+90 degrees is regarded as an azimuth angle detection range where no phase difference is generated, the phase difference (vertical axis) and azimuth angle (horizontal axis) between the beat signal, and synthesized beat signal are made to correspond to each other; and, therefore, the azimuth angle θ can be obtained uniquely from the phase difference φ. Owing to this, even when it is difficult to make the antenna distance narrower than the wavelength of the beat signal, the azimuth angle detection range can be widened.

Further, according to a preferred example of the second embodiment, it is possible to use the map data of FIGS. 15A and 15B in combination. When the map data of FIGS. 15A and 15B are compared with each other, in the map data of FIG. 15B, as described above, the azimuth angle can be obtained uniquely from the phase difference, whereas variations in the azimuth angle with respect to variations in the phase difference are smaller than in the map data of FIG. 15A. That is the azimuth angle resolving power, which can be obtained when the map data of FIG. 15B is used, is lower than the azimuth angle resolving power that can be obtained when the map data of FIG. 15A is used.

In view of this as shown in FIG. 16, firstly, using the map data M2 of FIG. 15B, there is detected an azimuth angle θ10 which corresponds to a phase difference φ. The then detected azimuth angle θ10 is detected with a relatively low azimuth angle resolving power. Next, when an azimuth angle corresponding to the phase difference φ is detected using the map data M2 of FIG. 15A, there can be detected azimuth angles θ20 and θ11. The then detected azimuth angles θ20 and θ11 are detected with a relatively high azimuth angle resolving power. Here, since an azimuth angle nearer to the azimuth angle θ10 detected using the map data M2 is the azimuth angle θ11, it can be determined that the azimuth angle θ20 is a virtual image resultant from the phase repetition. And, the azimuth angle θ11, which is detected with the high azimuth angle resolving power, is finally employed as a detected azimuth angle. In doing so, since the azimuth angle can be detected with a higher azimuth angle resolving power than when using only the map data M2 of FIG. 15B, the accuracy of the azimuth angle detection can be enhanced.

According to the preferred example of the second embodiment, in a case where there are used antennas 12_1, 12_2 and 12_3 as shown in FIG. 17, there can be obtained the same result as when azimuth angle detection using the antennas 12_1, 12_3 arranged at the distance of d and azimuth angle detection using the antennas 12_1, 12_2 arranged at the distance of d/2 are carried out in combination. That is, even when the number of antennas is smaller and it is difficult to narrow the antenna distance, the azimuth angle detection can be carried out with high accuracy.

FIG. 18 is a flow chart of an azimuth angle detection procedure according to the second embodiment. The procedure shown in FIG. 18 corresponds to the subroutine of the step S4a shown in FIG. 14. Firstly, the synthesizing unit 14a synthesizes a pair of beat signals respectively received by every adjoining paired antennas to thereby generate a synthesized beat signal (S40). Next, the azimuth angle detecting unit 14b, according to the phase difference between the beat signals and synthesized beat signal, detects an azimuth angle using a phase monopulse method (S44). Here, as an example, the azimuth angle is detected using the map data of FIG. 15B. According to this procedure, the azimuth angle detection range can be widened without changing the physical antenna distance.

When carrying out a procedure according to a further preferred example, the azimuth angle detecting unit 14b, according to the phase difference φ between the paired beat signals, detects an azimuth angle using the map data of FIG. 15B according to the phase monopulse method (S46), and an azimuth angle near to the azimuth angle detected in the step S44 is employed as a detected azimuth angle (S48). According to this procedure, when the azimuth angle detection range is widened, the azimuth angle detection accuracy can be enhanced.

As a further example of the above-mentioned first and second embodiments, it is possible to employ a method which widens the azimuth angle detection range according to the state of a target object. For example, the signal processing apparatus 14 does not carry out the azimuth angle detection range widening operation when the azimuth angle of a target object detected in the past exists ahead of one's own vehicle or when the relative distance of a target object is long. The reason for this is that it is not necessary to widen the azimuth angle detection range when detecting the target object existing ahead or distant from one's own vehicle and thus it can reduce an operation processing load when widening the azimuth angle detection range.

On the other hand, when the azimuth angle of a target object is near to the lateral direction of one's own vehicle or is near to one's own vehicle, by widening the azimuth angle detection range, the detection accuracy of the target object can be enhanced.

According to the present example, it is further possible to employ a method which widens the azimuth angle detection range according to the running state of the vehicle. In this case, the signal processing apparatus 14 obtains a running speed signal from a vehicle velocity sensor provided on one's own vehicle to thereby detect the running velocity of the vehicle. Or, it obtains a steering angle or a turning radius from a steering control unit or a yaw rate sensor to thereby detect that the vehicle 1 is turning. Since, when one's own vehicle is moving at a high speed or is moving along a straight road, there is a large probability that the target object, which is to be detected, itself is situated ahead of one's own vehicle, that is, in the forward direction of one's own vehicle, the signal processing apparatus 14 does not carry out the operation to widen the azimuth angle detection range. This can reduce the operation processing load of the apparatus 14 necessary to widen the azimuth angle detection range. On the other hand, since, when one's own vehicle is moving at a low speed or is turning a curve, there is a large probability that the target object to be detected is other vehicle forcing in from the adjacent lane near to one's own vehicle or a stationary object existing on the vehicle running lane, when the azimuth angle detection range is widened, the detection accuracy of the target object can be enhanced.

Here, when the radar apparatus 10 is mounted on a mobile object such as a ship or an aircraft, there can be employed a method which widens the azimuth angle detection range according to the moving state of the moving body. The signal processing apparatus 14 obtains a moving speed signal from a speed sensor provided on the mobile object to thereby detect the moving speed of the mobile object. Or, the apparatus 14 obtains a steering angle or a turning radius from a steering control unit or a yaw rate sensor to thereby detect that the mobile object is turning. And, since, when the mobile object is moving at a high speed or is going straight, there is a large probability that the target object to be detected is situated ahead in the moving direction of the mobile object, the signal processing apparatus 14 does not carry out the operation to widen the azimuth angle detection range. This can reduce the operation processing load of the apparatus 14 necessary to widen the azimuth angle detection range. On the other band, since, when the mobile object is moving at a low speed or is turning a curve, there is a large probability that the target object to be detected is situated in the other course than the moving course of the mobile object, by widening the azimuth angle detection range, the detection accuracy of the target object can be enhanced.

FIG. 19 is a flow chart of an operation procedure of the signal processing apparatus 14 according to the first and second embodiments. The procedure shown in FIG. 19 corresponds to the subroutine of the step S4 included in the main operation procedure shown in FIG. 4.

In the signal processing apparatus 14, the azimuth angle detecting unit 14b, according to the moving state of a Mobile object such as a vehicle or according to the state of the target object, determines whether it is necessary to widen the azimuth angle detection range or not (S50). And, when it is necessary (in Step S50, yes), the azimuth angle detecting unit 14b carries out the azimuth angle widening processing (S52). Here, the procedure shown in FIG. 14 or in FIG. 17 is executed as the subroutine of the step S52. On the other hand, when not necessary (in Step S50, no), the unit 14b carries out a DBF processing not including an azimuth angle widening processing or carries out an azimuth angle detecting processing according to the phase monopulse method (S54).

Such procedure can reduce the processing load of the whole of the signal processing apparatus 14. This can speed up the output of the detection results to the vehicle control unit 100, thereby being able to enhance safety in the vehicle control.

In the foregoing description, there has been illustrated the azimuth angle detecting method according to the DBF system or phase monopulse system. However, the above-mentioned first and second embodiments can be applied, besides the above illustrated methods, also to a well-known azimuth angle detecting method such as a MUSIC (Multiple Signal Classification) method, ESPRIT (Estimation of Signal Parameters via Rotational Invariance Techniques), or a CAPON method, provided that it is a method which detects the azimuth angle of a target object according to a phase difference between a pair of beat signals respectively obtained by a pair of antennas and also which narrows the antenna distance to thereby be able to widen a range where no phase repletion is generated.

As has been described heretofore, according to the invention, by synthesizing the paired signals to generate the synthesized beat signal, when a virtual antenna is interposed between the paired antennas, it is possible to obtain a synthesized beat signal having the same phase with a beat signal which is obtained by the virtual antenna. And, since, by detecting the azimuth angle of the target object according to a phase difference between the synthesized beat signal and one of the paired beat signals, the azimuth angle of the target object can be detected according to the paired beat signals respectively obtained by the paired antennas having a narrower antenna distance than the actual antenna distance, an azimuth angle detection range, where no phase repetition is generated, can be widened while the antenna distance is kept long to a certain degree.

1. A signal processing apparatus which is to be incorporated in a radar transmitter receiver including a transmission antenna which is configured to transmit a transmission signal, a plurality of reception antennas each of which is configured to receive the transmission signal reflected by a target object, and a generator which is configured to generate a plurality of beat signals for each of the receiving antennas, the signal processing apparatus comprising:
a synthesizer which is configured to synthesize the beat signals to generate a synthesized beat signal; and
a detector which is configured to detect an azimuth angle of the target object based on the synthesized beat signal and one of the beat signals.

2. The signal processing apparatus as set forth in claim 1, wherein the detector detects the azimuth angle of the target object based on a phase difference between the synthesized beat signal and the one of the beat signals.

3. The signal processing apparatus as set forth in claim 1, further comprising a corrector which is configured to correct one of a level of the synthesized beat signal and a level of one of the beat signals such that the level of the synthesized beat signal becomes equal to the level of the one of the beat signals,
wherein the detector detects the azimuth angle of the target object based on the synthesized beat signal and the one of the beat signals which are made equal to each other in level.

4. The signal processing apparatus as set forth in claim 3,
wherein the corrector corrects one of the level of the synthesized beat signal and a level of one of the beat signals, which corresponds to the detected azimuth angle such that the level of the synthesized beat signal becomes equal to the level of the one of the beat signals, and
wherein the detector further detects the azimuth angle of the target object based on the synthesized beat signal and the one of the beat signals which are made equal to each other in level.

5. The signal processing apparatus as set forth in claim 1,
wherein the radar transmitter receiver is to be mounted on a mobile object, and
wherein the detector selectively executes a first detection processing for detecting the azimuth angle of the target object based on the synthesized beat signal and one of the beat signals and based on a moving state of the mobile object or a state of the target object and a second detection processing for detecting the azimuth angle of the target object based on the beat signals.

6. A radar apparatus, comprising the radar transmitter receiver and the signal processing apparatus as set forth in claim 1.
